(19) United States
(12) Patent Application Publication
(10) Pub. No.: US 2002/0097955 A1
(43) Pub. Date: Jul. 25, 2002

(54) Device for exciting modes an optical waveguide

(76) Inventor: Andreas Himmler, Paderborn (DE)

Correspondence Address: BELL, BOYD & LLOYD, LLC, P. O. BOX 1135, CHICAGO, IL, 60690-1135, US

(21) Appl. No.: 09/990,966

(22) Filed: Nov. 16, 2001

(30) Foreign Application Priority Data
Nov. 16, 2000 (DE) 100 568 61.0

(51) Int. Cl. G02B 6/26

(52) U.S. Cl. 385/31

(57) ABSTRACT

A device for exciting modes in a fiber optic waveguide onto whose entry face part of a beam of a light source is directed, wherein another part of the beam of the light source is deflected onto the entry face via a reflector, and an interference pattern for the excitation of various modes is produced at the entry face.

### BACKGROUND OF THE INVENTION

The present invention relates to a device for exciting modes in an optical waveguide onto whose entry face part of a coherent beam of a light source is directed.

Fiber optic waveguides, also referred to as optical waveguides, are composed of a transparent core made of glass or transparent plastic, in particular acrylic glass, and a cladding which is also transparent. The core and cladding have different refractive indexes with the result that the light beams are guided in the core with low loss. The core here can be homogenous (step index fiber) or have a refractive index which is dependent on the position on the radius (graded index fiber). A multiplicity of designs of this type are known to the person skilled in the art. See in this respect, and for the general knowledge of the person skilled in the art, the manual “A. W. Snyder, J. D. Love:Optical Waveguide Theory; Chapman & Hall, 1983.”

In such a fiber optic waveguide there are various modes which are solutions of the wave equation for the respective waveguides. The fibers with essentially only one mode can be satisfactorily controlled but have the disadvantage that very thin cores and suitable monochromatic light sources are necessary. For this reason, for some applications, development is aimed at using fibers with a number of modes.

However, multimode fibers can be used efficiently only if it is possible also to excite the desired modes. One solution for this object can be found in patent U.S. Pat No. 5,892,866. Here, the light of a light source, generally a laser diode, is spatially fanned out through a first lens, sent through a phase filter and concentrated again with a second lens and collected at the entry face of the waveguide. The losses through two lenses and a phase filter are disadvantages with this solution.

The present invention is, therefore, directed toward exciting a number of modes with a small outlay and relatively low losses.

### SUMMARY OF THE INVENTION

Such goal is achieved in that another part of the beam of the light source is deflected onto the entry face via a reflector in such a way that an interference pattern for exciting various modes is produced. As a result, the overall expenditure becomes less; in particular, smaller designs become possible and the losses become smaller.

Accordingly, in an embodiment of the present invention, a device is provided for exciting modes in an optical waveguide, wherein the device includes an entry face onto which a part of a coherent beam of a light source is directed, and a reflector for deflecting another part of the coherent beam of the light source onto the entry face such that an interference pattern for exciting various modes is produced.

In an embodiment, the reflector is a planar mirror and the light source is arranged asymmetrically with respect to an optical axis of the optical wave length.

In an embodiment, the reflector is provided with a planar pattern.

In an embodiment, the pattern is holographic.

In an embodiment, the light source lies on an optical axis of the optical waveguide and the reflector surrounds a space between the light source and the entry face.

In an embodiment, the reflector is a cone envelope which encloses the space between the light source and the entry face.

In an embodiment, an inside of the reflector is mirrored.

In an embodiment, an inside of the reflector has a pattern.

Additional features and advantages of the present invention are described in, and will be apparent from, the following Detailed Description of the Invention and the Figures.

### BRIEF DESCRIPTION OF THE FIGURES

FIG. 1 shows a schematic view of an arrangement of the device according to the teachings of the present invention.

### DETAILED DESCRIPTION OF THE INVENTION

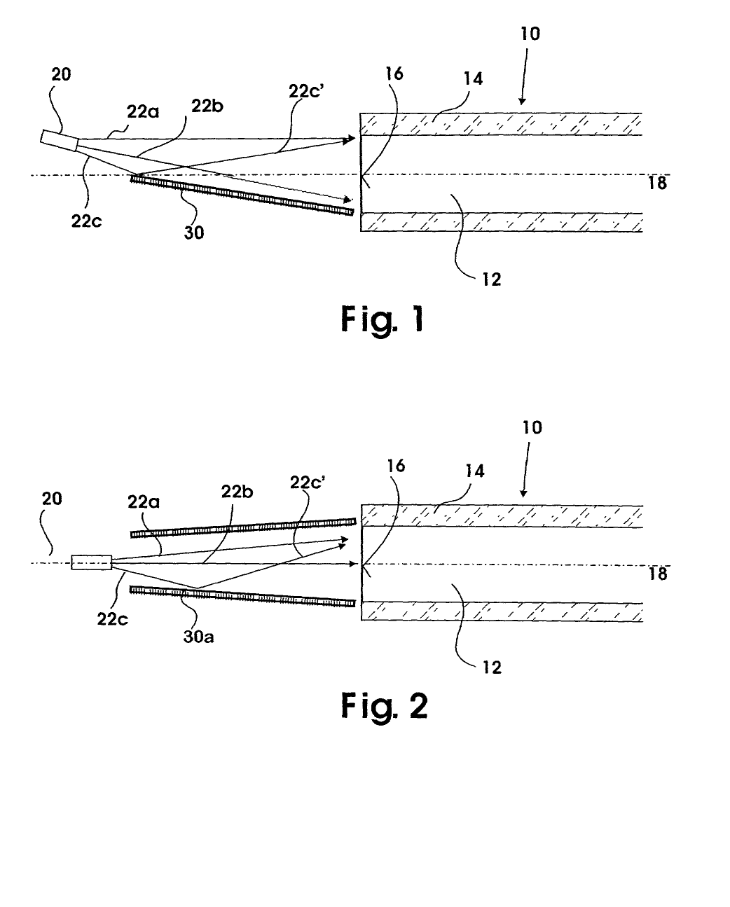

FIG. 1 is a schematic view of an arrangement according to the present invention. An optical waveguide 10 is composed of a core 12 and a cladding 14. Whether a step index fiber or graded index fiber is used is insignificant for the principle of the present invention. The optical waveguide 10 has an entry face 16 which is irradiated by a light source 20. The light source 20 is preferably a laser diode.

To date, the laser diode has been arranged as precisely as possible on the optical axis 18 of the optical waveguide as close as possible to the entry face 16 so that maximum light power is irradiated into the optical waveguide. However, it is apparent that only a small number of modes are excited in this way.

A particularly simple embodiment of the present invention displaces and rotates the laser 20 outward out of the axial position and removes it from the entry face 16. In the example, the optical axis of the laser 20 is no longer aligned with the center of the entry face but rather with its edge remote from it. In this way, only approximately half of the radiated power passes directly onto the entry face, indicated in FIG. 1 by the edge beam 22a and the central beam 22b.

Furthermore, a mirror 30 is provided which, in the simplest case, is a planar mirror. The mirror deflects the other part of the beam of the laser, represented by the lower edge beam 22c and the central beam 22b, onto the mirror, which deflects this beam onto the entry face, as illustrated by the reflected edge beam 22c′.

As a result of the difference in travel, an interference pattern is thus produced on the entry face 16 in a known fashion, with which pattern more modes are excited than as a result of the simple direct illumination of the entry face 16 by the laser 20. The calculation both of the interference pattern and of the associated mode excitation is presumed to be generally known to the person skilled in the art and therefore does not need to be explained further.

Apart from a simple homogenous planar mirror, all other respectively known mirrors also can be applied; for example, Lloyd mirrors, Fresnel mirrors and multi-layer (dielectric) mirrors. A multiplicity of intensity distributions on the entry face can be generated via a holographic pattern on the mirror which disrupts the surface in a selective fashion. This also applies to repetitive patterns which are applied to the mirror.

It is also possible to continue to leave the laser 20 in the optical axis and, as shown in FIG. 2, provide an internally reflective tube 30a between the laser 20 and entry face. This tube is, in the simplest case, a truncated cone. An internal part of the cone envelope of the laser is also directly incident on the entry face, while the outer part of the cone envelope is reflected by the tube 40. Here too, the tube also can be shaped in various ways on the inside. It does not, of course, need to be rotationally symmetrical with respect to the optical axis either, but rather can be composed, for example, of three trapezoids so that a triangular cross section is produced. Moreover, it can even be composed of just two opposite mirrored faces so that the reflector 30a surrounds the space between the light source 20 and entry face 16.

Although the present invention has been described with reference to specific embodiments, those of skill in the art will recognize that changes may be made thereto without departing from the spirit and scope of the invention as set forth in the hereafter appended claims.

1. A device for exciting modes in an optical waveguide, comprising:
an entry face onto which a part of a coherent beam of a light source is directed; and
a reflector for deflecting another part of the coherent beam of the light source onto the entry face such that an interference pattern for exciting various modes is produced.

2. A device for exciting modes in an optical waveguide as claimed in claim 1, wherein the reflector is a planar mirror and the light source is arranged asymmetrically with respect to an optical axis of the optical waveguide.

3. A device for exciting modes in an optical waveguide as claimed in claim 1, wherein the reflector is provided with a planar pattern.

4. A device for exciting modes in an optical waveguide as claimed in claim 3, wherein the pattern is holographic.

5. A device for exciting modes in an optical waveguide as claimed in claim 1, wherein the light source lies on an optical axis of the optical waveguide and the reflector surrounds a space between the light source and the entry face.

6. A device for exciting modes in an optical waveguide as claimed in claim 5, wherein the reflector is a cone envelope which encloses the space between the light source and entry face.

7. A device for exciting modes in an optical waveguide as claimed in claim 5, wherein an inside of the reflector is mirrored.

8. A device for exciting modes in an optical waveguide as claimed in claim 5, wherein an inside of the reflector pattern.
